(19) United States
(12) Patent Application Publication
(10) Pub. No.: US 2015/0176860 A1
(43) Pub. Date: Jun. 25, 2015

(54) LOW NOISE AIR CIRCULATION DEVICE

(71) Applicant: SMITHS MEDICAL ASD, INC., Rockland, MA (US)

(72) Inventors: Paul J. Hattan, Minnetonka, MN (US); Christopher Thorp, Minneapolis, MN (US); James P. Moorman, Bloomington, MN (US); Paul A. Pilosi, Minnetonka, MN (US); Robert Parsons, Braham, MN (US); Lynne M. Forrest, Eden Prairie, MN (US); William L. Beling, New Brighton, MN (US); Jay Ellingboe, New Brighton, MN (US); Kristin A. Finberg, Minneapolis, MN (US); Prathyusha Salla, Needham Heights, MA (US); Bryan C. Stoddard, Minneapolis, MN (US)

(73) Assignee: Smiths Medical ASD, Inc., Rockland, MA (US)

(21) Appl. No.: 14/559,994

(22) Filed: Dec. 4, 2014

Related U.S. Application Data
(60) Provisional application No. 61/918,053, filed on Dec. 19, 2013.

(51) Int. Cl. F24H 3/04; F24H 9/00; G10K 11/16

(52) U.S. Cl. CPC F24H 3/0417; G10K 11/16; F24H 9/0063

(57) ABSTRACT

An air warmer has a housing whereinto is positioned a noise reduction mechanism having a casing that encases a sound reducing structure having a maze like cavity. An axial fan is positioned within the sound reducing structure. In operation, air is drawn into the sound reducing structure by the fan along a first tortuous passage. The air is directed by the fan through another tortuous passage to an air outlet to inflate a convective blanket with an air hose connected to the air outlet. The configuration of the maze like cavity and the material from which the nosie reducing structure is formed reduce the noise generated by the fan. A heater is provided proximate to the air outlet to heat the output air. A filter is provided at the air inlet to filter the ambient air drawn into the warmer.

### FIELD OF INVENTION

The instant invention relates generally to air circulation devices and more particularly to a portable convective air warmer that is adapted to produce an air flow, at a low noise level, sufficient to inflate a convective blanket.

### BACKGROUND OF INVENTION

Convective patient air warmers and blankets are well known and widely used throughout the world today. A convective warmer is often used with a convective blanket to regulate the body temperature of a patient. The convective blanket is inflated by a continuous flow of heated air output from the warmer. The heated air in the blanket may be output to warm the patient through apertures at a surface of the blanket in contact with the patient.

When in operation, a conventional warmer produces a high level of noise. The noise, to a large extent, results from the movement of a centrifugal blower in the warmer to generate the stream of air flow needed to inflate a convective blanket. Centrifugal blowers may be desirable due to the air pressure produced for a given air volume. However, the operation of a centrifugal blower and its output air flow within the enclosure of a convective warmer tend to produce noise that can be substantial, and agitating to the patient and medical care providers. In addition to being noisy, warmers with centrifugal blowers tend to be large and bulky.

There is therefore a need for a compact, inexpensive, portable, lightweight, user-friendly convective warmer that is capable of producing sufficient air pressure to efficiently and effectively inflate a convective blanket while keeping the noise at a minimum.

### SUMMARY OF INVENTION

The inventive air circulation device is a convective blanket warmer that has a housing having a chamber fitted with a noise reduction muffler that is made of foam or other sound reducing materials. The muffler is configured to have air flow paths that are in the form of tortuous passages. Air is drawn into the housing of the warmer by way of an air inlet at the housing and output from the housing at its air outlet. The circulation of air is effected by an axial fan positioned in the muffler between and in fluid communication with the tortuous passages so that the inflow air and the outflow air pass along the fluid communication paths established by the tortuous passages.

By forming the tortuous passages from a sound reducing material, for example a foam having sound reducing properties, a substantial portion of the noise generated by the fan is trapped in the tortuous passages, or the cavity, of the muffler. The foam muffler is encased in or enclosed by a hard plastic shell, which also assists in the reduction of noise by reflecting at least a portion of the noise that passes through the foam wall of the muffler back into the cavity of the muffler.

The muffler may be formed as a single unit, or is formed by bonding two halves together. The muffler is encased by the plastic shell or casing, and is positioned in and secured to the housing of the air blower by a number of vibration isolation supports in the form of elastomeric ribs. These vibration isolation supports insulate the vibrations of the muffler, due to the movement of the fan therein, from the housing, to thereby ensure that most of the noise from the muffler is isolated and entrapped in the muffler. A space is formed between the outer wall of the casing and the inner wall of the blower housing.

The electronics that are needed to operate the blower of the instant invention may be provided onto a circuit board, or module, that is attached to the outer wall of the shell casing of the muffler. The electronic components at the circuit board therefore are positioned in the space between the inner wall of the blower housing and the outer wall of the shell. Vents or slots are provided at the warmer housing to establish a through path between the environment and the space. When there is a pressure drop in the space resulting from the operation of the warmer, a cooling airflow is drawn into the space to cool the electronic components, and other heat generating electrical components such as the power supply that may also be mounted onto the outer surface of the shell casing.

There is further provided in the muffler a heating element proximate to the air outlet at the end of the air outflow tortuous passage, so that the air being output from the warmer gets heated as it exits the blower. An air filter is provided at the air inlet of the blower housing to filter the ambient air drawn into the muffler.

The present invention is therefore directed to an air circulation device including a blower that comprises a housing having an inlet and an outlet and an inner wall defining a chamber, a noise reducing mechanism within the chamber having one and other tortuous passages, and a fan having an air intake and an air exhaust in fluid communication with the one and other tortuous passages. The one tortuous passage establishes an air input path between the inlet of the housing and the air intake of the fan and the other tortuous passage establishes an air output path between the outlet of the housing and the air exhaust of the fan so that air is drawn into the housing via the inlet and output from the housing via the outlet to inflate a convective blanket that is coupled to the outlet of the blower.

The present invention is further directed to a noise reduction mechanism or muffler that comprises: a sound trapping structure having formed therein one and other tortuous passages, the structure including a hold down portion that secures a fan to the structure, the fan having an air intake and an air exhaust positioned to be in fluid communication with the one and other tortuous passages, respectively, to establish an air inflow to the air intake of the fan and an air outflow from the air exhaust of the fan, the one and other tortuous passages disrupting the paths of the air inflow and the air outflow, respectively, as the fan operates to draw air to the air intake and output air from the air exhaust. The structure is adapted to be placed into a housing of an air blower having an air inlet and an air outlet so that air is drawn into the one tortuous passage of the structure from the air inlet and is conveyed to the other tortuous passage for output from the air outlet of the housing as the fan operates.

The present invention is further more directed to a method of reducing noise in an air blower, comprising the steps of;

(a) forming a sound trapping structure having therein one and other tortuous passages;

(b) securing a fan having an air intake and an air exhaust to a hold down portion of the structure;

(c) positioning the air intake and the air exhaust of the fan to be in fluid communication with the one and other tortuous passages, respectively, to establish an air inflow path to the air intake of the fan and an air outflow path from the air exhaust of the fan; and

(d) placing the noise reduction mechanism into a chamber of an air blower housing having an air inlet and an air outlet so that air is drawn into the one tortuous passage of the noise reduction mechanism from the air inlet and conveyed to the other tortuous passage of the noise reducing mechanism for output from the air outlet of the housing as the fan operates;

wherein the one and other tortuous passages disrupt the air inflow path and the air outflow path, respectively, to and from the fan as the fan operates to draw in air to the air intake and output air from the air exhaust.

### BRIEF DESCRIPTION OF THE DRAWINGS

The present invention will be apparent and the invention itself will best be understood with reference to the following description of the present invention taken in conjunction with the accompanying drawings, wherein:

FIG. 1a is a perspective view of an exemplar air circulation device, or air warmer, of the instant invention;

FIG. 1b is a rear view of the air warmer of FIG. 1a;

FIG. 2 is a simplified illustration of the air flow paths of an exemplar inventive noise reduction mechanism in the air warmer;

FIG. 3a is a top view of an exemplar convective warmer of the instant invention that depicts a mounting channel;

FIG. 3b is a rear view of the convective warmer of FIG. 3a;

FIG. 4 depicts a mounting system for use in concert with the mounting channel of the warmer;

FIG. 5 is a an illustration of a convective warmer disposed on a mobile cart;

FIG. 6a is a perspective view of a second embodiment of the air circulation device, or air warmer, of the instant invention;

FIG. 6b is a top view of the air circulation device of FIG. 6a;

FIG. 6c is a perspective back view of the device of FIG. 6a;

FIG. 7 is an exploded view of the various components of the air circulation device shown in FIGS. 6a-6c;

FIG. 8 is a perspective view of the noise reduction mechanism, or muffler, of the instant invention;

FIG. 9 is a cross-sectional plan view of the air reduction muffler shown in FIG. 8;

FIG. 10 is an illustration corresponding to the plan view of the muffler shown in FIG. 9 showing exemplar paths of the air flows through the muffler;

FIG. 11 is a top cut-away view of the air circulation device of FIGS. 6a-6c showing the inside of the muffler as well as the heater and the air filter provided therein;

FIG. 12 is a semi cross-sectional perspective view of the air circulation device of FIGS. 6a-6c showing the electronics mounted to the casing of the muffler and positioned in the space defined between the inner wall of the warmer housing and the outer wall of the muffler casing; and

FIG. 13 is a cross-sectional view of the air circulation device of FIG. 12 along line B-B.

### DETAILED DESCRIPTION OF INVENTION

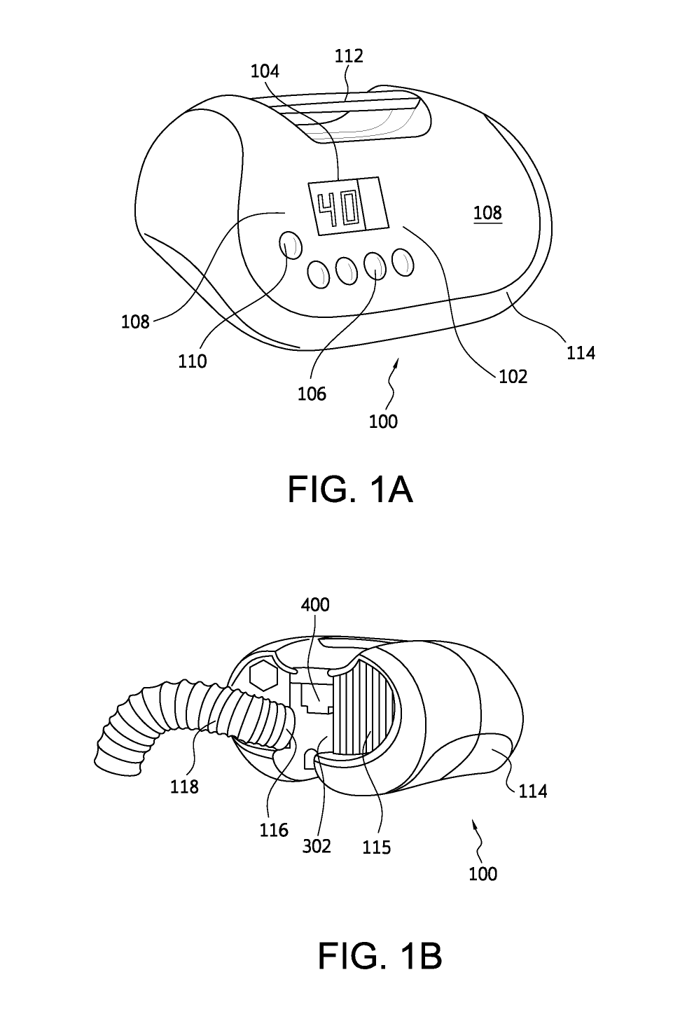

FIGS. 1a and 1b depict perspective views of an exemplar warmer 100 that has a housing 114 having provided at a front surface thereof a user interface 102 including a display 104, user controls including temperature selectors 106, alarm or warning indicators 108, and an on-off button or switch 110. A handle 112, which may be formed integral to housing 114, is provided at the top of the housing 114 so that the warmer can be carried.

There are provided at the rear surface of housing 114 an air inlet 115 and an air outlet 116. However, it should be appreciated that the air inlet and air outlet may each be provided at a surface of the housing that is different than that shown. For example, the air inlet and the air outlet may be provided on the respective side surfaces, or some other locations, of the housing.

Air outlet 116 is configured to removably accept a receptacle end of an air hose 118. In other embodiments, air hose 118 may be integrally formed with or otherwise coupled to warmer 100. Although not illustrated in the figures, an opposite end of air hose 118 is removably coupleable to a convective warming blanket, such as any one of the air inflatable blankets sold by Level 1, a subsidiary company of the assignee of the instant application.

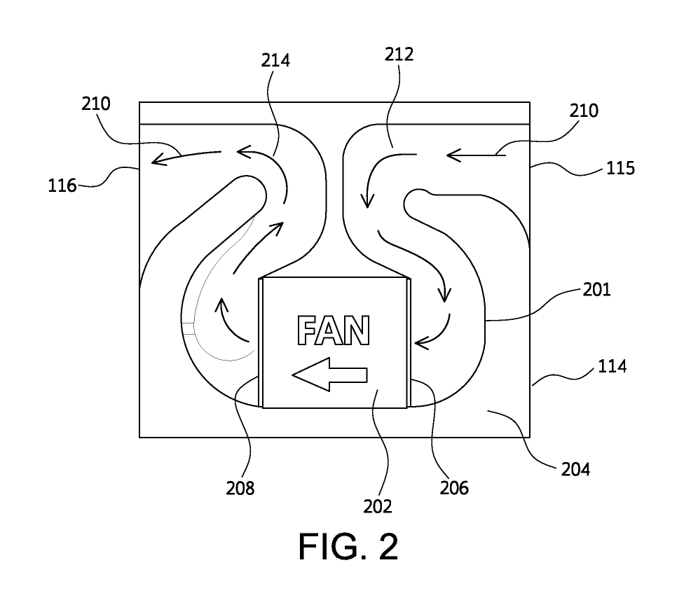

FIG. 2 is a simplified illustration of the paths of the air flows as directed by an axial fan 202 in the chamber 201 of a sound reduction mechanism or device 204 made from a noise reduction material, such as foam as will be discussed in detail infra. The sound reduction mechanism may also be referred to as a muffler in this application.

The sound reduction mechanism 204 is a structure that form fits within housing 114 as depicted in FIG. 1b. Axial fan 202 is arranged between air inlet 115 and air outlet 116. The blades (not depicted) of axial fan 202 force air to move generally parallel to the shaft about which the blades rotate to move air substantially along the axis of fan 202, or predominantly linearly. As such, in operation of warmer 100, axial fan 202 moves air in a generally straight line from axial fan intake 206 to axial fan exhaust 208, without an acute or right-angled bend or turn as found in conventional centrifugal blowers.

Among the advantages of using an axial fan in the inventive warmer is the ability to use a device having smaller physical dimensions than that of a conventional centrifugal fan, and subsequently a lighter weight, and a lower overall cost. Another advantage is that the axial fan is positioned within the sound reduction mechanism so that noise generated thereby is trapped by the sound absorbing walls of the passages of the mechanism. This latter advantage will be discussed in more detail, infra.

In conventional warmers, as the centrifugal blower inflates the convective blanket, back pressure (i.e., resistance to inflation) can be created by the blanket which affects the ability of the warmer to maintain a constant stream of pressurized air. Yet another advantage of using an axial fan in the warmer of the instant invention is that the effects of back pressure can be minimized due to the curvature of the axial fan blades which can be designed to maintain air flow through the full operating range.

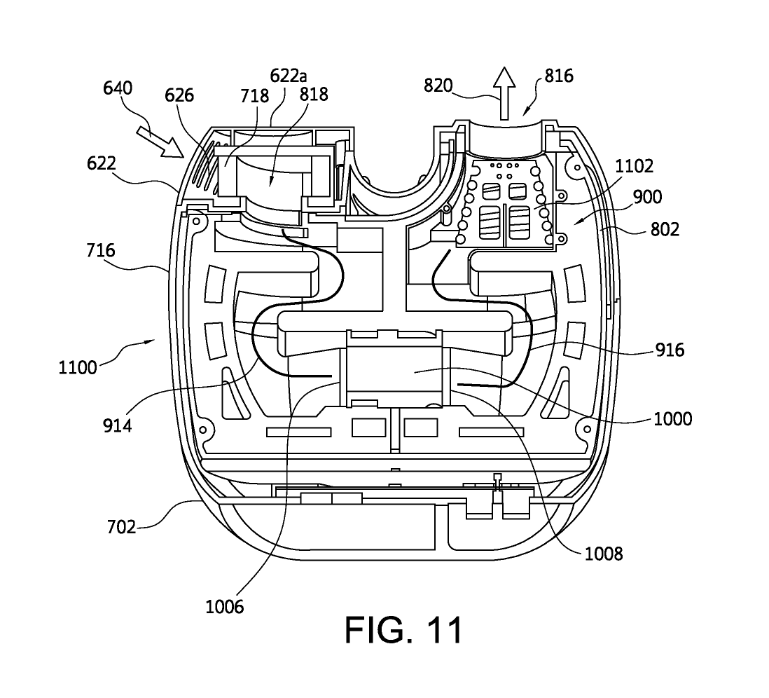

Warmer 100 heats the air via heating elements. A heating element may be placed on the exhaust side 208 of axial fan 202, such as at or near air outlet 116. One advantage of placing the heating element proximate to air outlet 116 or at exhaust side 208 is to improve the reliability of axial fan 202 by ensuring that axial fan 202 is not heated by the heated air. The configuration of the heating element may be generally cone- or Christmas tree-shaped, or comprise a wire, ribbon, straight, flat, coiled, tubular, tracked, or other similar or suitable structure. The heater may also be a part of a heater module such as that shown in the to be discussed sound reduction muffler of FIG. 11.

Some axial fans can create noise of approximately 79 dB or higher and can be noisier than centrifugal blowers, which are generally used in conventional warmers. Embodiments disclosed herein, however, provide for internal noise abatement, having minimal air flow pressure loss, resulting in lower noise output. Noise levels, at the warmer 100, may be reduced to be in a range of about 40 dB to about 70 db. In other embodiments, noise levels may be reduced to be in a range of about 45 dB to about 65 dB, or in a range of about 50 dB to about 60 dB. In still other embodiments, noise levels may be reduced to be in the range of about 50 dB to about 55 dB, such as in a range of about 52 dB to about 55 dB. As a point of reference, normal conversational speech is considered to be approximately 60 dB. Noise levels at hose output (i.e., at the connection to the convective blanket or other warming device) may be lower than the levels found at the warmer 100.

In the exemplar blower 100 of FIGS. 1a and 1b, internal noise abatement can be aided by incorporating a sound reduction mechanism or device in the chamber of the warmer. With reference to FIG. 2, the sound reduction mechanism may be configured to have passages that are arranged to minimize noise emissions from axial fan 202 while also minimizing pressure drop of the airflow. The indirect route(s) or tortuous passage(s) in the sound reduction mechanism is/are configured or molded from a sound reducing material, such as the foam discussed above. Additional materials and/or components may be added to increase the sound reduction properties of the sound reduction mechanism.

As shown in FIG. 2, the path of air flow 210 extends along a first or one tortuous passage 212 that establishes a first fluid communication path between air inlet 115 and intake 206 of axial fan 202, and a second or other tortuous passage 214 that establishes a second fluid communication path between air exhaust 208 of axial fan 202 and air outlet 116. For ease of discussion, the term “fluid communication path” is interchangeable with the term “tortuous passage” henceforth. Axial fan 202 is mounted within structure 204 and held therein by a hold down portion at a position that bridges the first and second tortuous passages 212 and 214. The tortuous passages may have shapes or configurations that are different from those shown in FIG. 2.

First tortuous passage 212 and second tortuous passage 214 may be substantially symmetrical, per depicted in FIG. 2. The walls that surround tortuous passages 212, 214 define curvatures that reflect noise inwardly within the passages, and possibly back toward axial fan 202, to provide noise reduction while minimizing air flow pressure loss. The curvatures or angles of the tortuous passages therefore act to maximize sound absorption by sound reducing material 204. The symmetry of tortuous passages 212 and 214 provides an advantage in that the respective air flows on both sides of axial fan 202 may cancel the noise generated by the fan to thereby acoustically reduce the overall noise of warmer 100.

Instead of being substantially symmetrical, first tortuous passage 212 and second tortuous passage 214 may be configured to follow different contours or curved paths in the chamber of the blower, so that there is non-symmetry between the first and second tortuous passages 212 and 214.

In one embodiment, sound reducing material 204 may comprise a foam material, as will be discussed further infra. In another embodiment, sound reducing material 204 may comprise one or a plurality of layers of foam and/or other sound abatement materials, with or without layers of air separation between some or all of the layers. In the case where the walls of the sound reduction mechanism is made from foam, the sound reducing foamed walls of first tortuous passage 212 and second tortuous passage 214 would absorb and reflect noise, to thereby dampen the noise and vibration from the fan. The foam may be a polyurethane foam or various permutations thereof. The sound reducing foam may also include open cell, non-self-skinning foam.

The sound reduction mechanism or muffler of the instant invention may be formed as a unitary piece, or may be assembled from sections of sound reducing material to provide a compact noise reducing structure.

In some embodiments, the sound reducing foam is partially or fully encased or enclosed by a hard shell casing that may be made from a plastic material, such as Acrylonitrile Butadiene Styrene (ABS), though other hard materials may also be used. The hard shell casing can be textured on one or more surfaces to provide further sound reducing qualities.

An air filter may be provided to the air inlet of the blower to filter the ambient air being drawn into the blower. The filter may be provided in the path of the tortuous passage that fluidly connects to the intake at fan 202. In addition to filtering the incoming air, the air filter may provide additional noise reduction.

In addition to the noise abatement advantages discussed above, warmer 100 is configured to be compact, lightweight and portable. To improve the ease of positioning and transport, warmer 100 is configured with handle 112 formed integral to, or affixed to, housing 114. Additionally, warmer 100 is attachable to an intravenous (IV) pole, a cart or some other structure by a mounting channel or recess formed in or on housing 114.

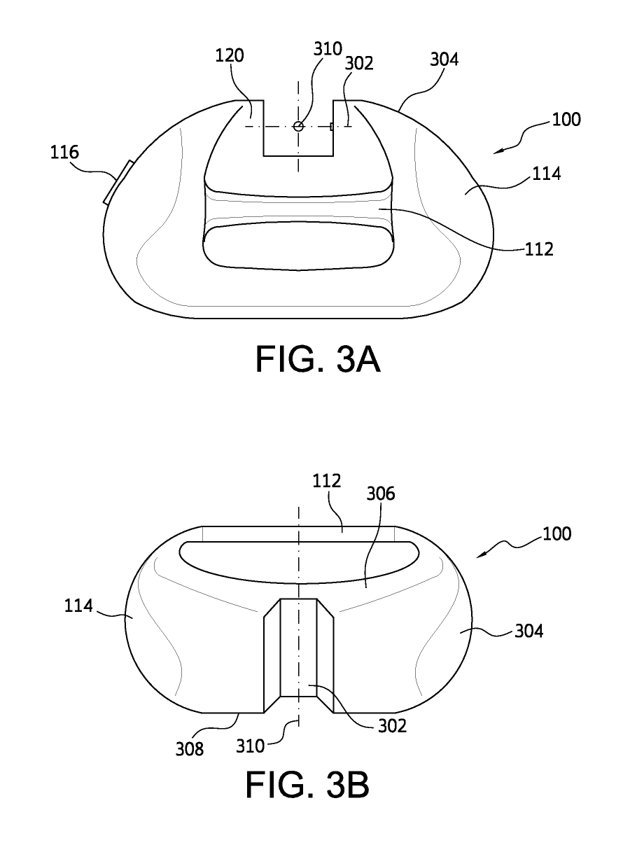

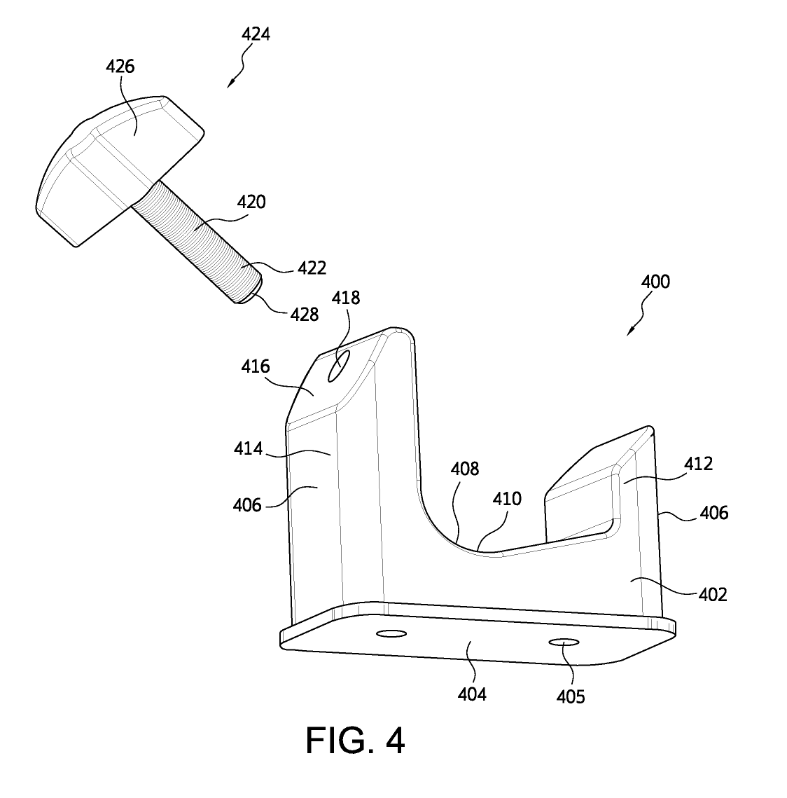

As depicted in FIGS. 3a and 3b, a channel 302 is positioned on a rear surface or portion 304 of housing 114. The particular configuration, placement and configuration of channel 302 can vary, such as to increase stability or weight balance of warmer 100 when attached as aforementioned. Thus, channel 302 can be formed generally central to the rear portion 304 or off-center in embodiments. Channel 302 can be sized, shaped or otherwise configured to accept various sizes and configurations of IV poles, cart attachment poles or other structures, such as mounting brackets 402 (FIG. 4). In the embodiment shown, channel 302 is substantially squared but it is understood that channel 302 can be any shape including, but not limited to, oval, circular, rectangular, v-shaped, slotted, etc. Channel 302 can be continuous, beginning at the top housing surface 306 and ending at the bottom housing surface 308 along a generally y-axis 310 as depicted, though other configurations can be implemented in other embodiments. An advantage of providing channel 302 recessed in the housing 114 is that when attached to an IV pole, warmer 100 is aligned more with the center of gravity of the IV pole, which can provide greater stability and allow a higher, more visible mounting location on the IV pole. In other embodiments, channel 302 can be omitted, with mounting bracket 402 or some other structure formed with or affixed to warmer 100 to enable mounting of warmer 100 to some other structure.

Mounting system 400, as illustrated in FIG. 4, cooperates with channel 302 for attachment to an intravenous (IV) pole, a cart or some other structure, including a wall. Mounting bracket 402 is configured to matingly attach to channel 302 such that bottom 404 conforms to the configuration of channel 302. In an embodiment, a plurality of mounting brackets 402 can be attached to channel 302. Bottom 404 defines at least one aperture 405 configured to accept mounting screws, pins, bolts or other attachment fasteners in order to attach the bracket 402 to the housing 114. Sides 406 can be configured to correspond to the configuration of the channel 302. Mounting bracket 402 comprises a receiver 408 that has an area of curvature 410, the area of curvature 410 configured to accept an IV pole or mounting pole. Mounting bracket 402 can be sized, shaped or otherwise configured to accept various sizes and configurations of IV poles or mounting poles and can vary from the particular configuration described and depicted herein. The mounting bracket comprises a first leg 412 and a second leg 414. Second leg 414 comprises an angled surface 416 defining an aperture 418. Aperture 418 is female threaded to matingly engage with male threads 420 on shaft 422 of retaining handle 424. Retaining handle further comprises a finger grip 426 attached to shaft 422.

In operation, shaft 422 is engaged with aperture 418 and can be rotated to advance distal end 428 of shaft 422 toward first leg 412. IV pole or mounting pole is positioned in the receiver 408 and distal end 428 of shaft 422 pushes against pole thus retaining the warmer 100 on the pole.

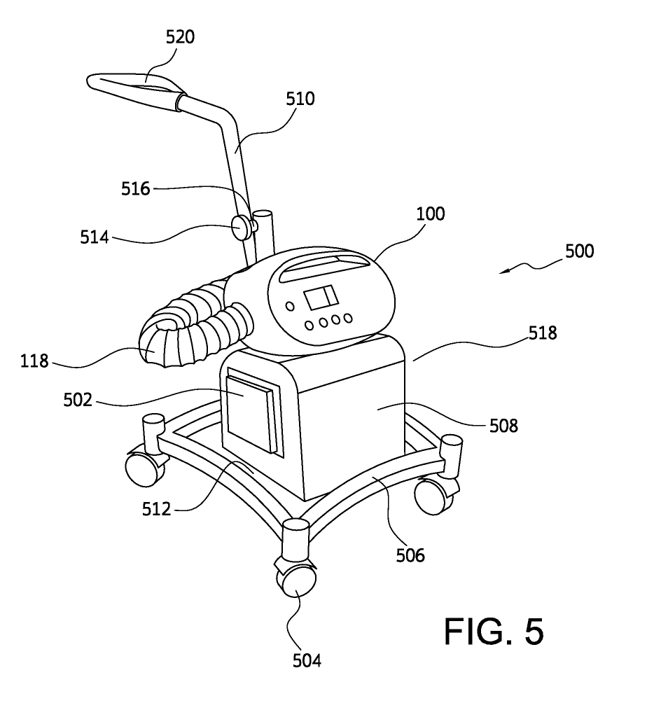

A warmer cart 500 is depicted in FIG. 5. Warmer cart 500 can be configured to store and/or transport warmer 100. Although the example of warmer 100 of FIG. 1a is depicted in FIG. 5, it is to be understood that any suitable convective warming unit could be used with cart 500. In addition to providing a convenient way for moving and positioning warmer 100, warmer cart 500 also can provide storage for compatible convective blankets 502, air hoses 118, accessories, components and other devices. Warmer cart 500 can be provided with swivel wheels 504 for easy maneuverability in embodiments. Wheels 504 are attached to a base 506 which is itself attached to a shelf unit 508 for mounting of warmer 100. In one embodiment, warmer 100 is positionable on the shelf unit 508 without being attached to cart 500. In one embodiment, warmer 100 and/or shelf unit 508 can be provided with non-slip feet, pads or mats. In another embodiment, warmer 100 is attached to cart 500 via mounting system 400 and channel 302.

Cavity 512 is defined between base 506 and shelf unit 508 and can provide a defined storage area for the convective blankets 502, air hoses 118, accessories, components and devices. Handlebar 510 can provide for convenient maneuverability of warmer cart 500. Handlebar 510 can be adjustable and repositionable so that the height and/or angle of its handgrip 520 can be customized at a comfortable use level for any particular user or to allow cart 500 to be arranged in a particular space or made more compact for storage or transport when not in use. Adjustment device 514 can be provided nearer the shelf unit 508. Adjustment device 514 can also include a mechanism 516 allowing handlebar 510 to be folded. Mechanism 516 can be released and tightened using a screw type configuration, a pin, a push button, or any other type of suitable release mechanism.

An electrical cord keeper 518 can be attached to shelf unit 508. Electrical cord keeper 518 allows a length of electrical cord to be neatly wound and easily accessible to a user while keeping unused length of electrical cord out of the way.

An advantage of warmer cart 500 for transporting warmer 100, blankets 502, air hose 118, accessories, components and devices, is that all required components of a convective warmer system can be centrally and conveniently maintained in an overall convective patient warming system. Another advantage is that wear and tear on warmer 100 itself can be reduced. In general, warmer cart 500 provides desirable and advantageous portability, stability, and compactness of the warming system.

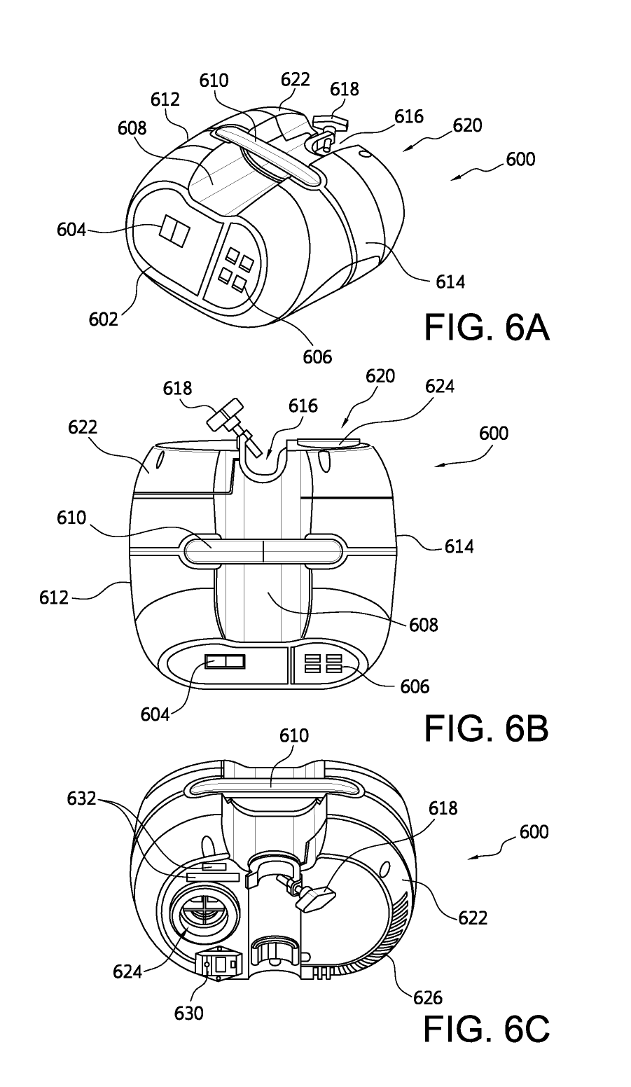

FIGS. 6a-6c show perspective views of a second embodiment of the convective air warmer of the instant invention. As shown, warmer, or air circulation device 600 has a front surface 602 that has a display 604 and controls 606 similar to those on the warmer shown in FIGS. 1a-1b. Similar to the earlier embodiment, a channel 608 is provided along the top surface of the warmer. A handle 610 is mounted to the housing of the warmer extending from its left side or top surface 612 to its right side or top surface 614, so that the warmer may be readily carried. Provided at the back of the warmer is a slot or channel 616 for mounting the warmer to an IV pole or other support, as was discussed previously. A threaded knob for the mounting assembly 618 anchors warmer 600 to the pole, as was also previously discussed.

In contrast to the earlier embodiment, per best shown in FIG. 6c, there is provided at the back 620 of warmer 600 a filter cover 622 that houses an air filter. A plurality of the air vents 626 to enable ambient air to be drawn into the warmer are provided at the lower side portion of air filter cover 622. An air output port or air outlet 624 is provided at the back of the warmer housing opposite to filter cover 622. Below air outlet 624 is a power entry module 630 to provide power to the warmer. Above air outlet 624 are air inlet vents 632 to enable ambient air to be drawn into the space that separates the warmer housing and the sound reduction muffler, as will be discussed in greater detail, infra. The air hose from an inflatable convective blanket may be coupled to air outlet 624 in a conventionally known manner so that the heated air output from warmer 600 may be conveyed through the hose to inflate the convective blanket.

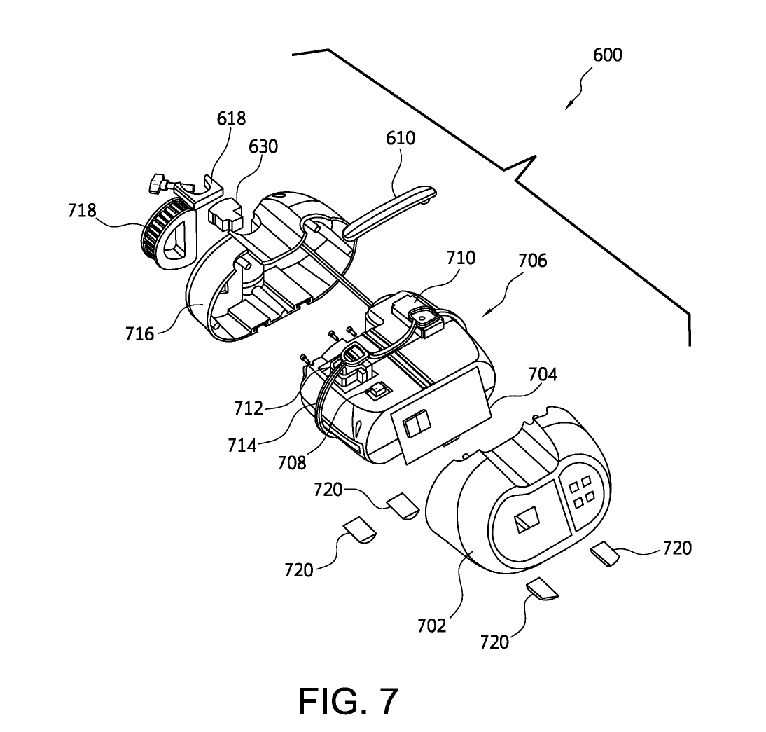

An exploded view of the various components of the warmer, or air circulation device 600, of FIGS. 6a-6c is shown in FIG. 7. As shown, the warmer includes a front housing portion 702. The above discussed display and controls are shown to be mounted to a PCB (printed circuit board) 704. A noise reduction mechanism, in the form of a muffler assembly 706, is shown to include an alarm speaker 708, a power supply 710, a power control board 712 onto which the electronics for controlling the operation of the warmer are mounted, a cable or wires 714 electrically connect the power supply 710 to the electronics control 712, and also the PCB 704. There is also shown a rear housing portion 716 that, together with front housing 702, enclose the muffler assembly 706. Further shown are the above discussed power entry module 630, the pole clamp unit 618, handle 610, and an air filter 718, discussed above to be housed inside filter cover 622. Rounding out the warmer 600 shown in FIG. 7 are four footpads 720 for the warmer housing. Although not shown, muffler assembly 706 includes a muffler proper, or a noise reduction mechanism or device, encased in a hard plastic shell. The particulars of the muffler assembly 706 will be discussed in detail below.

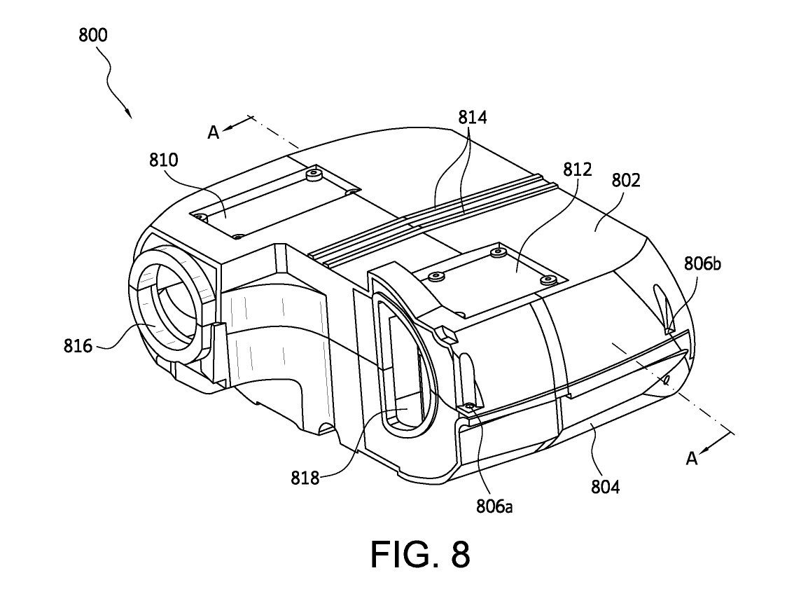

FIG. 8 shows a perspective view of the noise reduction mechanism or device, i.e., muffler, of the instant invention. Muffler 800 corresponds to muffler assembly 706 shown in FIG. 7, but without things mounted thereon. For the exemplar embodiment shown in FIG. 8, muffler 800 has a top shell 802 fittingly coupled to a bottom shell 804 by fastening means such as screws or bolts 806a and 806b, as conventionally known. Each of the top and bottom shells are made from a hard plastic material such as resin (including glass filled nylon), that enables the plastic shell to reflect as much noise as possible back into the muffler, as will be explained in greater detail below. The upper and lower outer shells of the muffler, may henceforth be referred together as the muffler shell or casing 800. Casing 800 is particularly effective at reflecting high frequency noise.

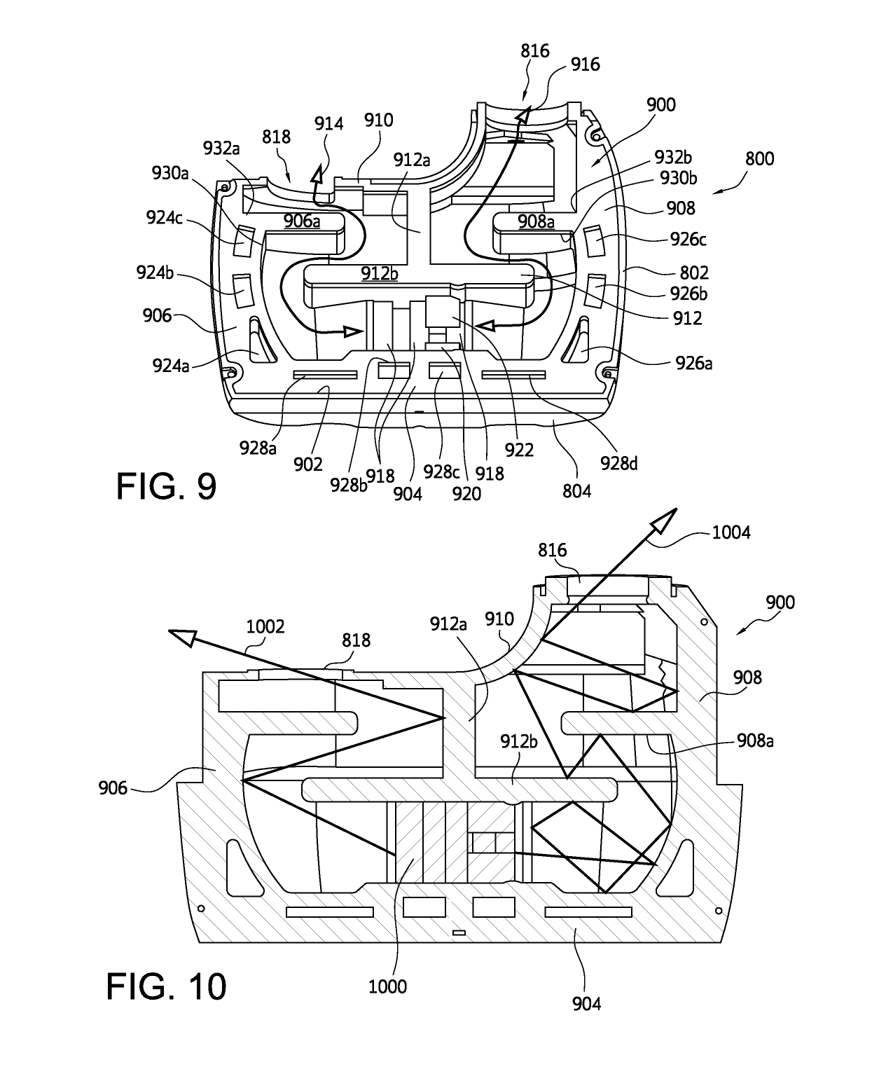

As further shown in FIG. 8, muffler casing 800 has an area 810 where the power supply 710 shown in FIG. 7 is mounted to. There is moreover an area 812 whereon the power control board 712 is mounted. There are two ribs 814 molded to the top of shell 802 for directing cooling air flow to the front of the muffler, as will be discussed further below. There is further shown air outlet 816 and air outlet 818 for the muffler. Muffler casing 800 is formed when the front and back housing half portions 702 and 716 are coupled together. When muffler casing 800 is placed into the chamber of the warmer housing, elastomeric ribs (FIG. 9) at the muffler are trapped and compressed between the outer wall of the casing and the inner wall of the warmer housing. These elastomeric ribs function as vibration isolation supports for firmly holding muffler assembly 706 within the warmer housing. As muffler assembly 706 “floats” on these isolation ribs, the vibrations and noise from the muffler assembly are not transferred to the warmer housing. The elastomeric ribs therefore prevent the vibrations and noise at the muffler assembly from being transferred to the warmer housing.

FIG. 9 is a transverse cross-sectional view along line A-A above the center of muffler casing 800. FIG. 9 shows a cross sectional view of the combination upper and lower plastic shells 802 and 804 together forming the casing that encases the noise reduction muffler, or simply muffler 900. Muffler 900 may be formed or molded as a single unitary structure or may be assembled from different parts, for example an upper muffler portion 902 and a lower muffler portion 904 per shown in FIG. 13. Muffler portions 902 and 904 may be assembled together using tongue and groove joints for their inner walls and lap joints for their outer walls. To ensure that the joints do not come apart under pressure, upper and lower muffler portions 902 and 904 may also be adhesively bonded to seal the joints.

As discussed above, muffler 900 may be made from a foam or other sound reduction materials. For the exemplar embodiment of FIG. 8, muffler 900 is made from a foam manufactured by Polymer Technologies, Inc. of Newark, Del., having part No. PF100-NS sold under the trade name POLYFORM. This foam is a specialized, open cell, non-skinned, flexible polyurethane foam that is molded to have a total density rating from 10 PCF to 12.5 PCF (pounds per cubit foot). It has been found that the foam provides good noise abatement.

As shown in the cross-sectional plan view of FIG. 9, and with reference to its front surface 902, muffler 900 has a front wall 904, a left sidewall 906, a right sidewall 908 and a back wall 910 that has a curvature between air inlet 818 and air outlet 816. In the cavity of muffler 900 there is a central member 912 in the shape of a reverse T, with a horizontal portion 912b and a vertical portion 912a that connects to back wall 910. Horizontal portion 912b comprises two partitions, one to the left side and the other to the right side of vertical portion 912a. There is moreover a partition 906a that extends from left sidewall 906 and another partition 908a that extends from right sidewall 908. Circumscribed by the sidewalls and interspersed with the partitions, the cavity of muffler 900 is shown to have a maze configuration that includes a first or one tortuous passage, designated by double ended arrow 914, that traverses between air inlet 818 and the location represented by mounting ribs 918, and a second or other tortuous passage, designed by double ended arrow 916, that traverses between air outlet 816 and mounting ribs 918.

Elastomeric ribs 918 are the vibration isolation supports that “floatingly” secure muffler assembly 800 to the inner surface of the warmer housing. The area where mounting ribs 918 are shown in FIG. 9 include extensions 920 and 922, which are used to securely hold an axial fan (1000 in FIGS. 10 and 11) to muffler 900. Extensions 920 and 922 may simply be referred to as a hold down portion for securing the axial fan to the foam structure of the muffler.

The upper and lower muffler portions, along with the hold down extensions 920 and 922, effect an interference fit between the foam body of the muffler and the axial fan positioned in the cavity of the muffler. This tight fit ensures that no air can leak around the fan. The compression by the foam to the fan further tightly confines the fan to the foam. With elastomeric mounting ribs 918 and other not shown vibration isolation rib supports floatingly securing the muffler assembly to the warmer housing, vibrations from the muffler that may result from the operation of the fan are reduced and not transmitted to the warmer housing.

Muffler 900 further has a number of air pockets along its front and sidewalls. These air pockets are labeled 924a, 924b and 924c in left sidewall 906; 926a, 926b and 926c in right sidewall 908; and 928a, 928b, 928c and 928d in front wall 904. The shapes of the different air pockets are selected from empirical studies, and are used to enhance the sound reduction properties of muffler 900 by absorbing noise that otherwise would escape from the body of the warmer.

Along the tortuous passages 914 and 916, the ends of the respective partitions 906a, 908a and 912b are rounded. However, there are sharp corners 930a and 930b at both surfaces where partition 906a meets left sidewall 906 and partition 908a meet right sidewall 908. These sharp corners tend to trap and absorb sound waves. The rounded corners at the ends of the partitions, on the other hand, facilitate the air flows along the tortuous passages.

As the airflow travels along the tortuous passages, the noise pressure waves associated therewith would bounce off the foam walls several times before exiting the muffler. This is because each time a sound wave is reflected off a wall, some of its energy is lost and its noise intensity is reduced. Additionally, the tortuous passages each create a longer travel distance for the sound waves to exit the system. This helps with the reduction of the noise level, since as a sound wave travels, it spreads out and loses its intensity. Therefore, a longer path for a sound wave to travel is also effective for the noise reduction. The paths that a sound wave travels along the tortuous passages of the muffler of the instant invention will be further discussed with reference to FIG. 10.

In addition to holding down the foam half portions tightly together and providing mounting locations for the other components such as the electronics and the power supply, the muffler casing formed from upper and lower shells 802 and 804 also enhances noise abatement by reflecting some of the sound that transmits through the foam structure back into the muffler. Thus, the muffler assembly made up of the hard shell casing encasing the sound reduction foamed muffler is effective in eliminating mid to high frequency noise.

FIG. 10 is a simplified illustration of possible paths traveled by sound waves in the maze structure of the muffler. As illustrated, an axial fan as discussed above, but in this instance designed 1000, is mounted to the muffler body and held thereat by a hold down portion as previously discussed. The sound generated by fan 100 travels as a sound wave along the tortuous passages 914 and 916. FIG. 10 illustrates a worst case scenario with the loudest sound, represented by sound wave path 1002 shown on the left side of the muffler. In this instance the sound wave generated from the fan travels to sidewall 906 and is reflected thereby to center wall partition 912a, and from there out through the air inlet 818. The right side of the maze structure of the muffler shows a more typical sound wave path 1004 where the sound emanating from fan 1000 first hits a curved portion of sidewall 908. From there the sound wave is reflected to the right-hand portion of partition 912b and gets reflected back to a part of the holding portion that holds fan 1000. The sound wave then is reflected to front wall 904 and from there reflected to sidewall 908. The thus reflected sound wave is next directed to a first surface of partition 908a, bounced off that partition to partition 912b and then reflected to a curved portion of back wall 910. The sound wave then is reflected back to the other surface of partition 908a, and from there back to side wall 908 then redirected back to back wall 910, and finally reflected out of air outlet 816. The typical sound wave path 1004 shown in FIG. 10 therefore illustrates that the sound wave is disrupted by the exemplar tortuous passage 916, so that the majority of the noise generated thereby is trapped within the cavity of the muffler body, before the sound wave traverses out of the muffler. Muffler 900 therefore is a noise abatement or reduction structure designed to trap a major portion of the noise generated by the fan during its operation within the maze structure. As discussed above, the hard shell casing that encases the foam structure of muffler 900 assists in the noise abatement by reflecting a major portion of the noise that passes through the foam structure of the muffler back to the foam structure.

FIG. 11 is a cross-sectional view of the inventive warmer showing the noise reduction muffler positioned in the chamber of the warmer housing. As shown, the hard shell casing 802 that encases the foam muffler is fittingly positioned into the chamber of warmer body 1100, when the back housing portion 116 and the front housing portion 702 are attached to each other. Fitted to the back wall of housing 1100 is the air filter cover 622, with air filter 718 housed therein. The opening 622a at air filter cover 622 leads to air inlet 818 of the warmer, more particularly the inlet of the muffler 900, so that filtered ambient air, designated by arrows 640, is drawn into the cavity of muffler 900, by way of input tortuous passage 914, to the air intake 1006 of fan 1000, when fan 1000 is in operation. The air is then driven by fan 1000 from air exhaust 1008 onto the output tortuous passage 916. The air flow output via air outlet 816 is designated by arrow 820. A heat module 1102 with heating elements thereat as is conventionally known may be positioned proximate to air outlet 816, so that the airflow through tortuous passage 916 passes the heating elements at heat module 1102 before being output from air outlet 816. As a consequence, heated air is output from the warmer shown in FIG. 11. When an air hose (not shown) of a convective blanket is coupled to air inlet 816 in a conventionally known manner, the heated air is conveyed through the air hose to inflate the convective blanket. As is conventionally known, apertures at a surface of the blanket that may be in contact with the patient, who is either lying on or is covered by the blanket, is warmed by the heated air.

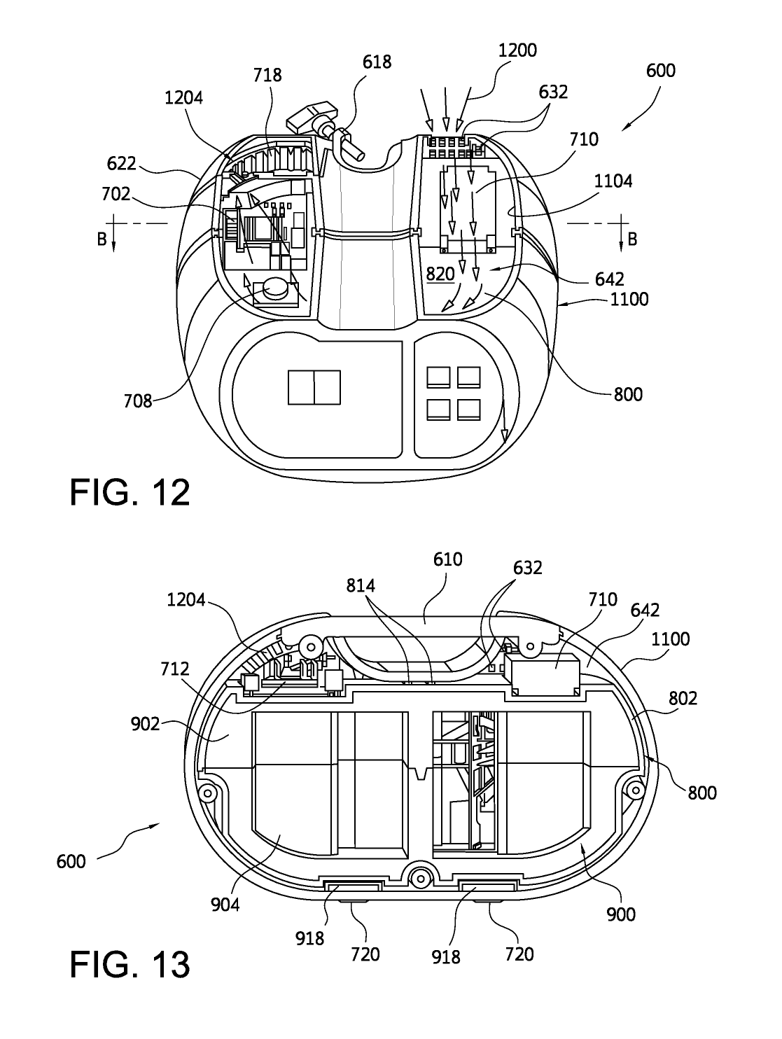

FIG. 12 shows air warmer 600 with a portion of the top of housing 1100 having been removed to expose a space 642 defined between inner wall 1104 of the warmer housing and outer wall 820 of muffler casing 800. As shown by the opening at the right side of blower 600, power supply 710 is mounted onto the top of the shell casing 800 within the defined space. At the opening on the left side of the blower, electronic module 712 that includes the electronics for controlling the operation of the warmer is shown mounted to the top surface of casing 800 within the defined space. Also mounted to the top surface of casing 800 within the defined space is alarm speaker 708, as previously described with reference to FIG. 7.

A secondary air flow is drawn into space 642 a number of secondary inlet vents 632 provided above air inlet 624, per shown in FIG. 6c. The secondary air inflow, designated by the arrows 1200, is a cooling air stream that gets drawn into the space between casing 800 and warmer housing 1100, guided by ribs 714 (FIG. 8) around the front of the device to pass over module 712, before exiting through a number of outlet vents 1204 into the space between filter cover 622 and filter 718. Thus, the cooling air stream flows along the path shown in FIG. 12 along the top of the muffler casing. As a result, the electronic components at power control board 712, as well as power supply 710 are cooled by the air stream. Once the cooling air exits through outlet vents 1204, it is sucked into the filter chamber where it mixes with the primary air flow 640 (FIG. 11) that is drawn into the cavity of muffler 900.

The cooling air flow is driven by a small pressure drop across the filter cover. The small pressure drop results from air passing through vents 626 at the filter cover 622 that creates a slight vacuum pressure in the filter chamber, i.e., the space between filter cover 622 and filter 718. The vacuum pressure may be adjusted by modifying the number or size of vents 626 in filter cover 622, i.e., adding or enlarging the vents to reduce the vacuum pressure, and removing or decreasing the size of the vents to increase the vacuum pressure. The cooling stream 1200 can therefore be adjusted to satisfy the cooling needs of the electronics and the power supply that are mounted to casing 800 within space 642.

FIG. 13 is a cross-sectional view along line B-B of FIG. 12 to further illustrate the space 642 defined between warmer housing 1100 and casing 800, as well as to show secondary air inlet vents 632 and air outlet vents 1204 at air filter cover 622 through which the cooling air stream 1200 passes. Note the longitudinal ribs 814 that separate the left and right halves of the blower to guide the cooling air stream to flow from air inlet vents 632 around the front of the housing and out through outlet vents 1204. Also shown in FIG. 13 is the press fitting of upper foam portion 902 and lower foam portion 904 to form muffler 900 encased in hard shell casing 802. Further shown are the vibration isolation ribs 918 that secure casing 800 to the warmer housing to isolate and prevent vibrations from muffler 900 caused by the operation of the fan from being transmitted to warmer housing 1100. Additional isolation vibration rib supports are provided at the sides of casing 800 to secure the casing to warmer body 1100.

With reference to FIGS. 9, 12 and 13, without limitation, an exemplar air warmer, and its noise reduction muffler may have the following dimensions. The height of the warmer housing may be between 100-250 mm, preferably between 140-200 mm. The height of the muffler may have a dimension within the range of the housing, preferably between 100-170 mm. The internal cavity of the muffler has various dimensions, due to the tortuous passage formations and the area where the hold down portion secures the axial fan. The width of the device can be anywhere from 250 mm to 400 mm, with a preference between 300-350 mm. With respect to the muffler, given the outer dimension of the warmer, as discussed above, the four walls of the muffler may have different thicknesses, per shown in FIG. 9. Partitions 912b and 912a, as well as partitions 906a and 908a may have a thickness of between 10 mm-20 mm, preferably between 14-18 mm. Of course, the dimensions given above would vary depending on the size of the convective warmer and therefore are not limited by the dimensions as discussed above for the exemplar convective warmer shown in FIGS. 6a-6c.

It should also be appreciated that the exemplary embodiments disclosed above are illustrative only and are not intended to limit the scope of the instant invention. It should further be understood that various changes can be made in the function and arrangement of the elements described above without departing from the scope of the subject matter as set forth in the appended claims.

1. An air blower, comprising:
a housing having an inner wall defining a chamber, an inlet and an outlet;
a noise reducing mechanism within the chamber having one and other tortuous passages; and
a fan having an air intake and an air exhaust in fluid communication with the one and other tortuous passages, respectively;
wherein the one tortuous passage establishes an air input path between the inlet of the housing and the air intake of the fan, and the other tortuous passage establishes an air output path between the outlet of the housing and the air exhaust of the fan;
wherein air is drawn into the housing via the inlet and output from the housing via the outlet; and
wherein when a convective blanket is coupled to the outlet of the blower, the blanket is inflated by the air output from the outlet.

2. The blower of claim 1, further comprising a heater positioned along the other tortuous passage proximate to the outlet so that air output from the blower is heated by the heater.

3. The blower of claim 1, wherein the noise reducing mechanism comprises a structure having at least one air inflow partition at the one tortuous passage in a blocking relationship to the inlet and at least one air outflow partition at the other tortuous passage in a blocking relationship to the outlet, the one and other tortuous passages configuring the structure into a noise abatement maze to trap at least a portion of the noise generated by the fan when the fan is in operation.

4. The blower of claim 3, wherein the noise reducing mechanism further comprises an other air inflow partition at the one tortuous passage in substantial parallel relationship to the one air inflow partition and an other air outflow partition at the other tortuous passage in substantial parallel relationship to the one air outflow partition.

5. The blower of claim 1, wherein the noise reducing mechanism comprises a structure pre-formed from a noise reducing material and encased in a casing that has an outer wall configured to be fittable into the chamber of the housing, selective portions of the outer wall of the casing secured to corresponding portions at the inner wall of the housing by vibration isolation supports.

6. The blower of claim 1, wherein the noise reducing mechanism comprises a sound reduction structure encased in a casing having an outer wall mounted at selective portions to the inner wall of the housing to thereby define a space that separates the outer wall of the casing and the inner wall of the housing;
wherein electronics components for the blower are mounted to the outer wall of the casing; and
wherein a cooling air flow is drawn into the space to cool the electronic components during the operation of the blower.

7. The blower of claim 1, further comprising an air filter positioned proximate to the air inlet to filter the air drawn into the one tortuous passage.

8. The blower of claim 1, wherein the noise reducing mechanism comprises a structure made from a foam having noise reduction properties;
wherein the structure comprises an upper foam portion and a lower foam portion bondingly secured to each other to form the one and other tortuous passages; and
wherein the foam structure is conformably encased in a casing.

9. The blower of claim 1, wherein the one and other tortuous passages in the noise reducing mechanism are symmetrical to each other with each of the tortuous passages having at least a pair of partitions positioned between the respective inlet and outlet of the housing and the fan so that the respective air flows along the one and other tortuous passages each change from one direction to at least another direction while traversing along its corresponding tortuous passage, each of the air flows encountering at least one sharp corner along its corresponding tortuous passage.

10. A noise reduction mechanism, comprising:
a sound trapping structure having formed therein one and other tortuous passages, the structure including a hold down portion that secures a fan to the structure, the fan having an air intake and an air exhaust positioned to be in fluid communication with the one and other tortuous passages, respectively, to establish an air inflow path to the air intake of the fan and an air outflow path from the air exhaust of the fan, the one and other tortuous passages changing the direction of the air inflow path and the air outflow path, respectively, as the fan operates to draw in air from the air intake and output air to the air exhaust; wherein the structure is adapted to be placed into a chamber of an air blower housing having an air inlet and an air outlet, air being drawn into the one tortuous passage of the structure from the air inlet and is conveyed to the other tortuous passage for output from the air outlet of the housing as the fan operates.

11. The noise reduction mechanism of claim 10, wherein the structure is made from a foam that has noise reducing properties;
wherein the structure is conformably encased in a casing; and
wherein the structure traps at least a portion of the noise generated by the fan as inflow air and outflow air traverse along the one and other tortuous passages, respectively, and the casing reflects at least a portion of the noise escaping from the structure back into the structure when the fan is in operation.

12. The noise reduction mechanism of claim 11, wherein the structure comprises at least one partition positioned at each of the one and other tortuous passages to alter the direction of the paths of the air inflow and air outflow along the one and other passages, the one and other tortuous passages effecting a noise abatement maze in the structure to trap the noise generated by the fan.

13. The noise reduction mechanism of claim 11, wherein the casing is positioned in the housing with selective portions at the outer wall of the casing secured to corresponding portions at the inner wall of the housing by vibration isolation supports that prevent the transfer of vibrations from the casing to the housing, a space separating the outer wall of the casing and the inner wall of the housing.

14. The noise reduction mechanism of claim 10, wherein the structure is encased in a casing; and
wherein the casing has mounted to its outer wall electronic components for at least controlling the operation of the fan, a cooling air flow is drawn into the space to cool the electronic components during the operation of the fan.

15. The noise reduction mechanism of claim 10, further comprising a heater positioned along the other tortuous passage proximate to the air outlet to heat air being output from the air outlet.

16. The noise reduction mechanism of claim 10, further comprising an air filter positioned proximate to the air inlet to filter the air being drawn into the one tortuous passage.

17. A method of reducing noise in an air blower, comprising the steps of:
(a) forming a sound trapping structure having therein one and other tortuous passages;
(b) securing a fan having an air intake and an air exhaust to a hold down portion of the structure;
(c) positioning the air intake and the air exhaust of the fan to be in fluid communication with the one and other tortuous passages, respectively, to establish an air inflow path to the air intake of the fan and an air outflow path from the air exhaust of the fan; and
(d) placing the noise reduction mechanism into a chamber of an air blower housing having an air inlet and an air outlet so that air is drawn into the one tortuous passage of the noise reduction mechanism from the air inlet and conveyed to the other tortuous passage of the noise reducing mechanism for output from the air outlet of the housing as the fan operates;
wherein the one and other tortuous passages disrupt the air inflow and the air outflow, respectively, to and from the fan as the fan operates to draw in air to the air intake and output air from the air exhaust.

18. The method of claim 17, further comprising the steps of:
forming the structure from a foam that has noise reducing properties; and
conformably encasing the structure in a casing;
wherein the structure traps noise along the one and other tortuous passages and the casing reflects at least a portion of the noise escaping from the structure back into the structure.

19. The method of claim 17, further comprising the steps of:
positioning at least one partition at each of the one and other tortuous passages to alter the paths of the air flows along the one and other tortuous passages to effect a noise abatement maze in the structure to trap at least a portion of the noise generated by the fan.

20. The method of claim 17, wherein the step d further comprises the steps of:
encasing the structure in a casing;
mounting the casing inside of the housing by securing selective portions at the outer wall of the casing to corresponding portions at the inner wall of the housing with vibration isolation supports to effect a space separating the outer wall of the casing and the inner wall of the housing; the method further comprising the steps of:
mounting to the outer wall of the casing electronic components for controlling at least the operation of the fan; and
establishing a pressure drop in the space to draw in cooling air to cool the electronic components during the operation of the fan.

21. The method of claim 17, further comprising the steps of:
providing an air filter proximate to the air inlet to filter the air being drawn into the one tortuous passage; and
positioning a heater along the other tortuous passage proximate to the outlet to heat air being output from the air outlet.
